(19) United States
(12) Patent Application Publication
(10) Pub. No.: US 2026/0244508 A1
(43) Pub. Date: Aug. 20, 2026

(54) Job Execution Management with De-Centralized Policy Implementation

(71) Applicant: Oracle International Corporation, Redwood Shores, CA (US)

(72) Inventor: Johnson Manuel-Devadoss, San Antonio, TX (US)

(73) Assignee: Oracle International Corporation, Redwood Shores, CA (US)

(21) Appl. No.: 19/057,301

(22) Filed: Feb. 19, 2025

(51) Int. Cl. G06F 9/50; G06F 9/48; G06N 20/00

(52) U.S. Cl. CPC G06F 9/5038; G06F 9/4881; G06F 9/5066; G06F 2209/484; G06N 20/00

(57) ABSTRACT

Techniques for executing workflows in a de-centralized computing environment are disclosed. A controller generates a policy using a multi-agent reinforcement learning (MARL) algorithm. The algorithm trains independently-acting agents to select a set of actions to complete a set of jobs that meets a set of optimization criteria. The system generates the policy based on the actions selected by the independently-acting agents. The agents correspond to processing nodes in a computing environment. The processing nodes implement the policy to independently select jobs for execution from a set of jobs in a workflow. As the processing nodes complete jobs, the processing nodes provide results data to a policy generator to retrain the agents with the MARL algorithm to generate an updated policy for executing jobs in the computing environment.

### TECHNICAL FIELD

The present disclosure relates to software job management. In particular, the present disclosure relates to generating a job deployment policy with a centralized controller to be implemented by independently executing, de-centralized processing nodes.

### BACKGROUND

An orchestration platform is a tool or application that coordinates complex workflows. The platform manages the execution of multiple tasks by multiple nodes to execute a larger process. Orchestration platforms may coordinate the workflows automatically without human intervention. The orchestration platform ensures all parts and processes required to execute the workflows work together smoothly and in the correct order. Computer software and/or services providers may utilize orchestration platforms to manage workflows for developing and testing software applications as well as to distribute the software applications, updates, and services to customers. For example, a software delivery platform may implement a continuous integration/continuous delivery (CICD) model to deploy, manage, and scale application and infrastructure resources in real-time. The software delivery platform may utilize multiple processing nodes to provide the processing infrastructure resources for the deployment and management of applications and software services.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIGS. 1A and 1B illustrate a system in accordance with one or more embodiments;

FIGS. 2A-2C illustrate an example set of operations for generating and implementing a de-centralized job execution strategy for workflows in accordance with one or more embodiments;

FIGS. 3A-3C illustrate an example embodiment; and

FIG. 4 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. REINFORCEMENT-LEARNING-BASED JOB MANAGEMENT ARCHITECTURE
3. REINFORCEMENT-LEARNING-BASED JOB MANAGEMENT
4. EXAMPLE EMBODIMENT
5. COMPUTER NETWORKS AND CLOUD NETWORKS
6. HARDWARE OVERVIEW 7. MISCELLANEOUS; EXTENSIONS

### 1. General Overview

One or more embodiments execute workflows using a centralized controller and de-centralized processing nodes that each independently determine which processing nodes are to execute which jobs. The centralized controller generates a job-execution policy. The de-centralized processing nodes execute the job-execution policy by obtaining and executing jobs independently of each other or without communicating with other processing nodes to determine the jobs each processing node will execute. The centralized controller generates the job-execution policy using a multi-agent reinforcement learning (MARL) algorithm. The algorithm trains agents embodied as software constructs to represent the processing nodes in a physical system. The agents receive state information, such as available actions to take, and select actions independently of each other or without one agent communicating with another to determine the actions the other agents are taking. The actions represent jobs executed by the processing nodes in the physical system. The MARL algorithm uses a joint-action value to reward agents for actions that result in maximizing the combined performance of all the agents. For example, the algorithm may designate a greater reward for actions that would result in a faster completion of a set of jobs or by minimizing the resources required to complete the set of jobs. The centralized controller iteratively applies the MARL algorithm to improve the joint actions of the agents. A system generates a job-execution policy based on the improved joint actions of the agents. The job-execution policy improves the combined performance of processing nodes represented by the agents. The processing nodes implement the policy to independently determine resources to apply to execute a set of jobs comprised in a pending workflow. In an example, both a first processing node and a second processing node may independently determine that a particular job is to be executed by the first processing node. As a result of the determination by the first processing node, the first processing node executes the particular job. As a result of the same determination by the second processing node, made independently of the first processing node, the second processing node refrains from executing the particular job.

As the processing nodes complete jobs, the system updates a set of training data used to train the agents by the MARL algorithm. The system re-runs the MARL algorithm on the updated data set to generate an updated job-execution policy. Accordingly, the system generates job-execution policies that capture changes in performance of processing nodes over time and changes in computing environment characteristics over time. Furthermore, as the system updates job-execution policies based on results of previously executed jobs, the system learns over time the most efficient job-execution strategies for a particular computing environment.

One or more embodiments iteratively provide a set of independent deep reinforcement learning agents with a state, associated with characteristics of a computing environment, and a set of actions associated with the state. An agent selects an action to apply to the state to generate a next state. Another agent also selects an action without communicating with other agents regarding other action selections. Based on an agent’s action selection, the system provides the agent with (a) the next state, (b) another set of candidate actions to apply to the next state, and (c) a reward associated with the next state. The reward represents a performance of all the action selections of all the agents resulting in the next state. An agent selects an action to apply to a particular state based on a reward value associated with the next state generated by applying the action to the state. The agent may select an action to apply to a state of a computing environment based on (a) a reward value of a candidate next state associated with a candidate action, (b) a discount factor or penalty associated with the candidate next state, and (c) an estimate of an optimal future value of future next states that follow from the particular candidate next state. As a result of iteratively selecting actions to apply to states of the computing environment, the system generates a sequence of actions to apply to a sequence of states. The system analyzes the sequence of actions for the set of agents to generate a job-execution policy for a set of independently executing processing nodes. The job-execution policy may include separate policies for separate processing nodes. The set of independently executing processing nodes implement the job-execution policy to execute a set of jobs in a workflow.

One or more embodiments implement the agent as an action-selecting neural network. The system trains the neural network with a training data set made up of a set of sequences of actions applied to respective sequences of states of the computing environment and the workflow. The system trains the neural network to select an action, from among a set of candidate actions, to apply to a particular state of the computing network. By iteratively selecting actions to generate different sequences of actions, the neural network learns an action-selection policy that corresponds to a highest reward value for a sequence of actions.

One or more embodiments described in this Specification and/or recited in the claims may not be included in this General Overview section.

### 2.Reinforcement -Learning- Based Job Management Architecture

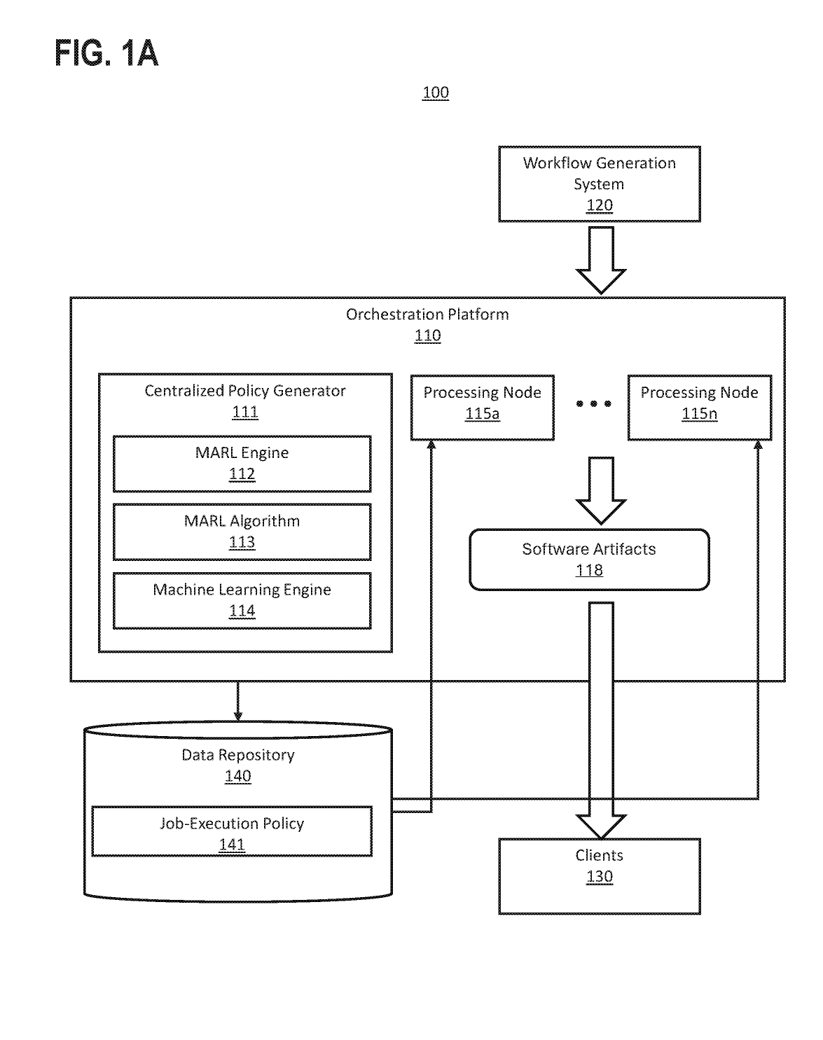

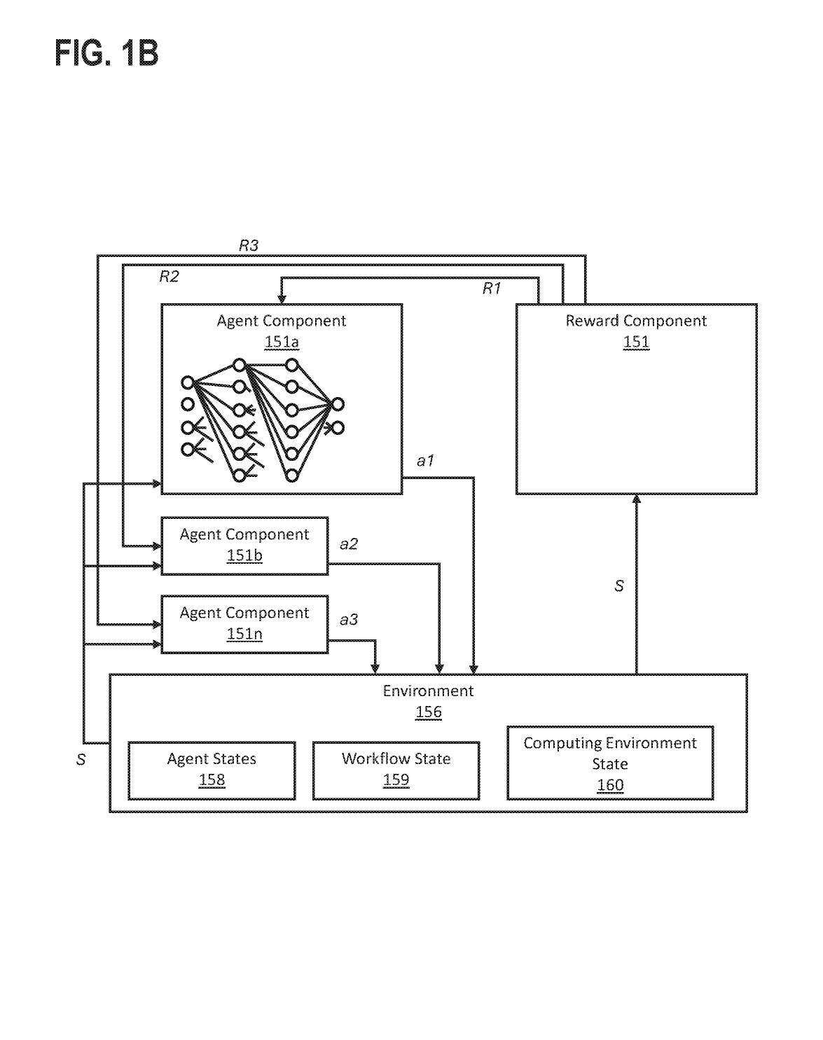

FIGS. 1A and 1B illustrate a system 100 in accordance with one or more embodiments. As illustrated in FIG. 1A, system 100 includes an orchestration platform 110, a workflow generation system 120, clients 130, and a data repository 140. In one or more embodiments, the system 100 may include more or fewer components than the components illustrated in FIG. 1A. The components illustrated in FIG. 1A may be local to or remote from each other. The components illustrated in FIG. 1A may be implemented in software and/or hardware. Each component may be distributed over multiple applications and/or machines. Multiple components may be combined into one application and/or machine. Operations described with respect to one component may instead be performed by another component.

Additional embodiments and/or examples relating to computer networks are described below in Section 5, titled “Computer Networks and Cloud Networks.”

An orchestration platform 110 includes hardware and software to orchestrate the execution of jobs generated by the workflow generation system 120. A workflow generation system 120 may be, for example, an application, a set of applications, a computer system associated with an entity, such as a company, or any other computer or set of computers that generates a workflow to be executed. Workflows include sets of jobs. As used herein, jobs are units of work to be executed by processors in processing nodes 115a-115n. Jobs are further made up of tasks.

For example, a workflow generation system 120 may generate a workflow to deploy a set of software code to one or more clients 130. The clients 130 represent computers or computer systems managed by entities. The entities may be organizational units within an organization, customers external to an organization, or any other type of entity associated with computers or computer systems. The workflow includes a set of jobs to be executed by the processing nodes 115a-115n. Examples of jobs to be executed by the processing nodes 115a-115n include preparing a software artifact for installation on a client system, preparing updates to be applied to configuration files in the client system, generating sets of changes to database schemas, generating software modules to manage application restart operations in the client devices, generating software processes to perform health checks of installed software, generating software processes to collect log data from client devices, preparing software to facilitate security patch deployment, and preparing software to facilitate data migration between client devices or from a database to a client device. Upon completion of the set of jobs in the workflow, the orchestration platform 110 may transmit one or more software artifacts 118 to clients 130 to deploy the software code in the clients 130.

As another example, a workflow generation system 120 may generate a workflow to upgrade software in applications running on one or more clients 130. The workflow includes a set of jobs to be executed by the processing nodes 115a-115n, such as generating software to perform pre-upgrade checks of applications running on the clients 130, downloading software upgrade packages to the clients 130, monitoring installation of the update to the clients 130, verifying installation of the updates in the clients 130, managing restarting services to the clients 130, managing data migration to the clients 130, and reporting on upgrade status from the clients 130.

As illustrated in the above examples, in some examples, processing nodes 115a-115n generate software artifacts 118 to be executed in clients 130. In other examples, processing nodes 115a-115n interact with the clients 130 to perform jobs, such as checking and validating code, values, and data stored in the clients 130.

The orchestration platform 110 includes a centralized policy generator 111 to generate a centralized job-execution policy 141 to be implemented by the processing nodes 115a-115n to execute jobs. The processing nodes 115a-115n execute the job-execution policy 141 independently of each other. In other words, the processing nodes 115a-115n execute the job-processing policy without determining from other processing nodes 115a-115n what jobs are being processed by the other processing nodes 115a-115n.

The centralized policy generator 111 generates the job-execution policy 141 using a multi-agent reinforcement-learning (MARL) algorithm 113. The MARL algorithm 113 is implemented and managed by a MARL engine 112. The MARL algorithm 113 provides state data and rewards to multiple agents that act concurrently to perform a set of actions. In some embodiments, the MARL algorithm 113 employs n agents, where n corresponds to a number of processing nodes 115a-115n. The agents are embodied as software constructs that are modified based on feedback from the MARL algorithm 113. The centralized policy generator 111 modifies the agents based on the feedback from the MARL algorithm 113 to cause the agents to learn optimal behavior given sets of state data and options for taking actions based on the state data. The optimal behavior may be completing a set of jobs in a workflow generation system 120 by the agents, representing processing nodes, in a shortest amount of time, compared to executing jobs in other sequences among the processing nodes.

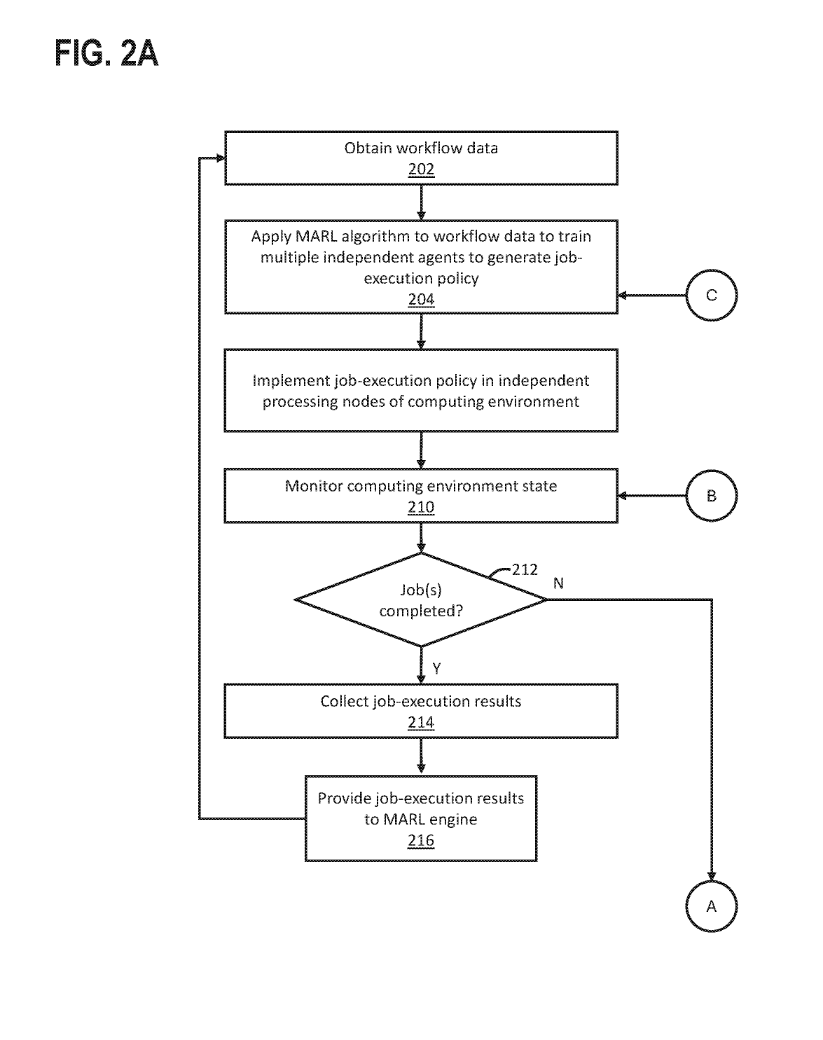

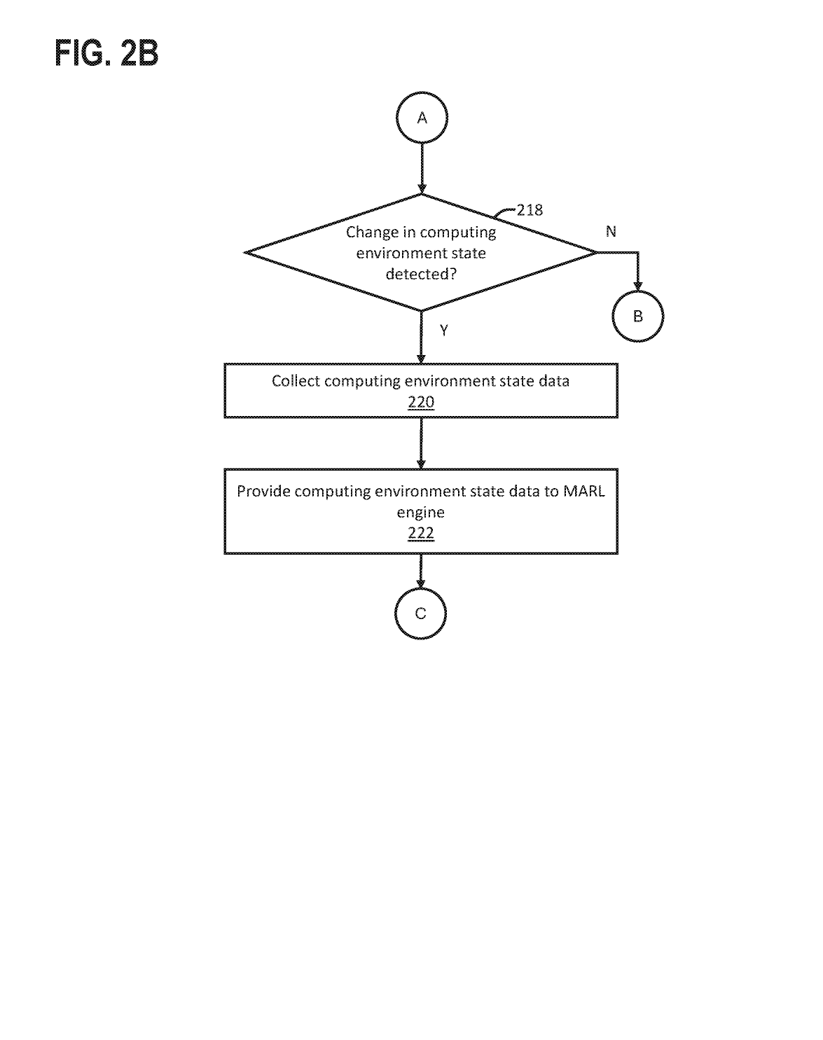

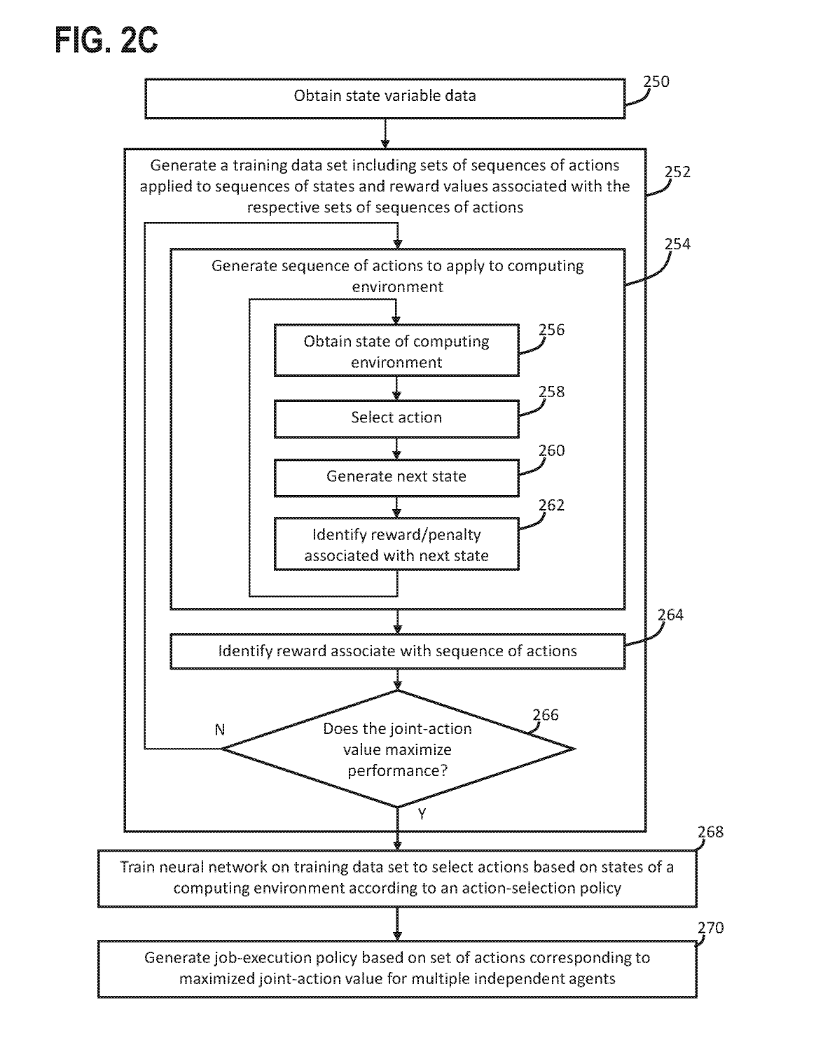

In an embodiment, the agents are implemented as neural networks. The MARL algorithm 113 provides rewards data and state data to a machine learning engine 114 to train the neural networks to learn sequences of actions that improve a joint-action value. The joint-action value represents the performance of the set of agents that generate action decisions. Based on a set of action decisions, the MARL algorithm 113 (a) identifies a next state of a computing environment and (b) identifies a reward associated with the next state. The operation of the MARL algorithm 113 is described in further detail in FIG. 2C.

In some examples, one or more elements of the machine learning engine 114 may use a machine learning algorithm to train the agents embodied as neural networks to select particular actions. A machine learning algorithm is an algorithm that can be iterated to learn a target model f that best maps a set of input variables to an output variable using a set of training data. Various types of algorithms may be used, such as linear regression, logistic regression, linear discriminant analysis, and naïve Bayes.

In an embodiment, a set of training data includes datasets and associated labels. The datasets are associated with input variables. In embodiments, target variables include state data, such as available actions, agent state data, and environment state data as well as rewards for a previous state selection. The associated labels are associated with the output variable (e.g., an action taken by the agent representing an action taken by a processing node in a physical system) of the target model f. The training data may be updated based on, for example, feedback from the MARL algorithm 113 such as rewards for actions selected. Updated training data is fed back into the machine learning algorithm, which in turn updates the target model f by modifying weights, parameters, and offsets of neurons in the neural networks.

FIG. 1B illustrates an example of an interaction between the MARL algorithm 113 and agents 151a-151n embodied as neural networks. In FIG. 1B, the reward component 151 and the environment 156 represent information represented in the MARL algorithm 113. The environment 156 stores data representing agent states 158, a workflow state 159, and a computing environment state 160. Examples of agent states 158 include an agent’s capacity to select actions. For example, in an embodiment where the agents 151a-151n represent processing nodes, if an agent 151a selects an action to perform that corresponds to executing a job, the agent state 158 may reflect an amount of time required for the agent 151a to finish executing the job. The amount of time may correspond to a processing capacity of a processing node 115a represented by the agent 151a. Workflow state 159 represents a number of jobs available to be selected for execution by agents 151a-151n. Workflow state 159 may further include job attributes, such as job priority, job size, and computing resources required to execute a job. Computing environment state 160 represents a state of a computing environment affecting the actions available to the agents 151a-151n. For example, if an agent 151a finishes executing an action (representing a processing node executing a job) and if a computing environment lacks bandwidth to transmit data from the executed job to a destination, the computing environment state 160 may reflect that the agent 151a is unable to select an action to begin a new job until data from the previous job has been sent to a destination.

The environment 156 provides state data S to the agents 151a-151n. The agents select actions a1, a2, and a3 based on the state data S. The environment 156 updates the state data for the agent states 158, workflow state 159, and computing environment state 160 based on the actions a1, a2, and a3. The reward component 151 receives the state data for the next state based on implementing actions a1, a2, and a3 from the environment 156 and generates reward data R1, R2, and R3. The reward component 151 provides the reward data R1, R2, and R3 to the agents 151a-151n. The environment 156 provides the state data S for the next state to the agents 151a-151n. The agents 151a-151n select a next set of actions to take based on the state data S and the reward data R1, R2, and R3.

In embodiments, the agents 151a-151n select actions a1, a2, and a3 independently of each other or without knowledge of actions selected by other agents. The reward component 151 generates the reward data for the respective agents based on if the combined actions of the agents resulted in an improved result, as compared to other possible results associated with other possible actions. In an embodiment where agent actions represent selecting jobs to execute, selecting whether or not to split jobs among agents and selecting whether or not to join jobs from among multiple agents to a single agent, the improved result may correspond to a result that is more likely to lead to a set of jobs in a workflow being executed by a set of processing nodes in the shortest amount of time.

Returning to FIG. 1A, the centralized policy generator 111 generates the job-execution policy 141 based on the set of actions determined based on the MARL algorithm 113 to improve the joint-action value. The job-execution policy 141 specifies sets of computing state conditions and corresponding processing node actions such as selecting jobs from a workflow queue to execute. The orchestration platform 110 provides the job-execution policy 141 to the processing nodes 115a-115n. The processing nodes 115a-115n run the job-execution policy to determine jobs to select from among jobs included in a workflow, whether or not to divide jobs into sub-jobs among multiple processing nodes, and whether or not to merge jobs into a single job at a processing node.

In one or more embodiments, a data repository 140 is any type of storage unit and/or device (e.g., a file system, database, collection of tables, or any other storage mechanism) for storing data. Furthermore, a data repository 140 may include multiple different storage units and/or devices. The multiple different storage units and/or devices may or may not be of the same type or located at the same physical site. Furthermore, a data repository 140 may be implemented or executed on the same computing system as the orchestration platform 110. Additionally, or alternatively, a data repository 140 may be implemented or executed on a computing system separate from the orchestration platform 110. The data repository 140 may be communicatively coupled to the orchestration platform 110 via a direct connection or via a network.

Information describing a job-execution policy 141 may be implemented across any of components within the system 100. However, this information is illustrated within the data repository 104 for purposes of clarity and explanation.

In one or more embodiments, an orchestration platform 110 refers to hardware and/or software configured to perform operations described herein for generating a job-execution policy using a MARL algorithm to execute sets of jobs by de-centralized processing nodes. Examples of operations for using MARL techniques to execute jobs in a de-centralized manner are described below with reference to FIGS. 2A-2C.

In an embodiment, an orchestration platform 110 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a server, a web server, a network policy server, a proxy server, a hardware load balancer, a mainframe, a communication management device, and/or a client device.

### 3. Reinforcement-Learning-Based Job Management

FIGS. 2A-2C illustrate an example set of operations for implementing a job-execution policy in a de-centralized manner in accordance with one or more embodiments. One or more operations illustrated in FIGS. 2A-2C may be modified, rearranged, or omitted. Accordingly, the particular sequence of operations illustrated in FIGS. 2A-2C should not be construed as limiting the scope of one or more embodiments.

In an embodiment, the system obtains a set of workflow data (Operation 202). The workflow data includes attributes of a set of jobs included in a workflow. Attributes include, for example, a job priority, a job size (e.g., a number of instructions, a number of lines of code, a size of a digital file storing the job), processing requirements, including a number of threads required to process the job, and a size of memory required to store the job. Attributes may further include a source and a destination of a job or workflow. For example, a job may originate from a particular application. Additionally, or alternatively, a job may originate from a particular software development team or a server associated with the team. Destinations may include a destination application, clients, or destination devices. Attributes may include bandwidth requirements to execute the job.

In one or more embodiments, the workflow data includes historical workflow data of previously executed jobs and/or workflows. The historical workflow data may include (a) jobs comprised in previously executed workflows and (b) results of executing the jobs. For example, results may include an amount of time required for a processing node to execute a job and processing resources (such as processors, threads, and/or memory) required to execute the job.

In one embodiment, the workflow data includes data of a pending workflow. For example, an orchestration platform may generate a workflow comprising a set of jobs to be executed to process and distribute a software update to client applications. As another example, the orchestration platform may generate a workflow comprising a set of jobs to be executed to generate software artifacts for a software application to be rolled out or published to customers and/or clients.

Workflows include sequences of operations, or jobs, to perform functions, such as deploying software in a computing environment, upgrading software, and deploying, upgrading, or modifying applications in client devices. Workflows are made up of jobs or discrete sets of tasks that are performed by processing nodes in the computing environment. Processing nodes execute jobs in parallel to efficiently execute workflows. Examples of jobs executed by processing nodes include the following: backing up data, applying schema changes, updating database tables, running integrity checks, stopping application services, replacing old application files with new versions, restarting services, purging cache data, updating web server configuration data, reloading website content, checking for compatibility issues, updating device firmware, configuring new network settings, and checking connectivity in client devices. Processing nodes may perform jobs to upgrade and deploy applications. Processing nodes may further perform jobs to generate software artifacts that allow other devices to perform the upgrade and deployment operations.

The system applies a MARL algorithm to the workflow data to train a set of independently-operating agents to generate a policy for executing the set of jobs comprised in the workflow across multiple, independently operating processing nodes (Operation 204). The system applies the MARL algorithm to multiple independently acting agent components that select actions independently of each other. Agent components are software constructs that are trained to select beneficial actions based on receiving rewards for previously selected actions. In one embodiment, agents are software constructs configured to execute sets of instructions. Based on receiving feedback from previous selections, the system modifies the sets of instructions to result in either reinforcing past selections or causing the agent to make different selections. In an alternative embodiment, agents are implemented as independent neural networks. The system assigns the characteristics of corresponding processing nodes in a physical system to agents. As a result, the rewards assigned to one agent for selecting an action based on a present state may differ from the rewards assigned to another agent for selecting the same action based on the same present state, reflecting how one processing node may more efficiently perform a job than another. For example, if a job-execution platform has five processing nodes to process jobs in a workflow, the MARL algorithm may include, and train, five agents to take actions independently of each other. An example process for applying the MARL algorithm to the workflow data is illustrated in FIG. 2C.

Referring to FIG. 2C, the system obtains state variable data (Operation 250). The state variable data includes state information describing characteristics of resources in a computing environment. The state variable data includes a workflow state. The workflow state includes, for example, jobs in a workflow queue and characteristics of the jobs. The state variable data of the jobs in the workflow state may include training data comprised of historical workflows executed in a system and historical results of executing the workflows. The state variable data further includes agent states. The agents may represent processing nodes in a physical system. The state variable data may include state data for the processing nodes, such as processors available, virtual machines (VMs) available on a node, and memory available on the node. State variable data may further include characteristics of a computing environment, such as available bandwidth between system components and available system memory that is external to the processing nodes.

For example, workflow state data may specify an action corresponding to executing a job. The job may correspond to a particular size. A first agent representing a first processing node comprising a first number of processing cores may require 1 minute to execute the job based on the job size and the resources of the first processing node. A second agent representing a second processing node comprising a second number of processing cores may require 30 seconds to execute the job. The system applies the MARL algorithm to train the first agent and the second agent to optimize decisions to select actions, such as selecting jobs for execution, dividing jobs among processing nodes, and joining jobs to a single processing node based on the workflow state data, the agent state data, and the computing environment state data.

The state variable data includes reward data and penalty data associated with particular states. Rewards and penalties are values attributed to particular states to provide feedback to an agent of a deep reinforcement learning process. A higher reward incentivizes the agent to obtain a particular state. A lower reward, or a higher penalty, disincentivizes the agent to obtain a particular state. Reward values and penalty values may be attributed to particular states based on characteristics of the states, such as a time required to complete an action to arrive at a particular state and computing resources required for a particular state.

In one or more embodiments, the system is configured to improve rewards for independently executed agent actions that result in an overall performance improvement of all the agent actions. For example, executing Job 1 by Agent 1 may result in Agent 1 being available to take another job sooner than if Agent 1 executes Job 2. However, the overall result may be that Agents 2 and 3 are less efficient at executing Job 2 than Agent 1 is, so the overall system performance among all the Agents suffers. Consequently, the system provides Agent 1 with a lower reward, no reward, or a penalty for executing Job 1. The system provides Agent 1 with a higher reward for executing Job 2 based on the benefit to the performance of all the Agents when Agent 1 executes Job 2.

The system generates a training data set that includes sets of sequences of actions applied by multiple agents respectively to sequences of states and reward values associated with the respective action/state pairs (Operation 252). The system generates the training data set by applying, using multiple independent agents, sequences of actions to sequences of states until a threshold is reached. The threshold may include a duration of time. The threshold may include a reward value. The threshold may include a bounded reward value, including an upper bound and a lower bound. For example, the system may apply, by the multiple independent agents, a sequence of actions to a respective sequence of states until a reward value associated with the sequence of states reaches a maximum value. The system may apply another sequence of actions to another respective sequence of states until a reward value associated with the sequence of states reaches a minimum value.

The system generates, using the multiple independent agents, a sequence of actions to apply to states representing a computing environment (Operation 254) by (a) obtaining a state representing characteristics of resources of a computing environment (Operation 256), (b) selecting an action, from among a plurality of candidate actions, to apply to the state (Operation 258), (c) applying the selected action to the state to modify the state to generate a next state (Operation 260), and (d) identifying a reward value or penalty value associated with the next state (Operation 262). The system repeats the process (a)-(d) by selecting, for the next state, another action from among another plurality of candidate actions to apply to the next state. The system performs (a)-(d) iteratively until a threshold is reached. In one or more embodiments, the sequence of (a)-(d) is referred to as a “step.” The sequence of steps that is performed until the threshold is reached is referred to as an “episode.” In one embodiment, the threshold includes a predefined number of steps. In other words, if a maximum reward value is not reached within the predefined number of steps, the episode is completed.

In one or more embodiments, operations (a)-(d) are performed independently for the multiple independently operating and concurrently operating agents. In Operation 256, an agent receives state data based on previous selections of all agents. The agent may receive state data representing a workflow such as a set of pending jobs to be executed by processing nodes. The agent selects an action (Operation 258). Each agent selects a respective action without communicating with other agents about their action selections. The system determines the next state associated with the action selected by (a) the agent and (b) actions selected by the other independently operating agents (Operation 260). For example, Agent 1 may select an action to execute Job 5. The next state includes jobs still left in a workflow queue. If Agent 2 selected an action to execute Job 6, then the next state may include a workflow queue including Jobs 7, 8, and 9.

During training of the agents, two independently-executing agents may select the same action, representing executing the same job. The system provides reward feedback to discourage duplication in subsequent action selections, such as by rewarding one agent for the action and penalizing the other. In an embodiment where an agent is a neural network, penalizing the agent results in modifying parameters of the model to cause the model to select a different action for the same state data input. The selection rewards is based on maximizing a joint-action value as described below.

In one embodiment, a feedback loop is integrated for the reward-based training of the agents to generate a job-dispatch policy. The outcomes of a matching process (e.g., processing nodes implementing a MARL-generated dispatch policy to match jobs to processing nodes) are directly linked to the reward mechanism applied in subsequent trainings of the MARL algorithm, offering continuous feedback that enables ongoing improvements to the deployment and scheduling policies

For each episode, the system calculates the reward value associated with the sequence of actions that comprise the episode (Operation 262). For example, the system may assign relatively high reward values to states which result in maximizing the number of actions selected by agents and minimizing the number of steps required to select the selected actions. Conversely, the system may assign relatively low reward values, or relatively high penalty values, to states which result in fewer actions selected or more steps required to select the actions across all the independently operating agents. Additionally, or alternatively, the system may assign relatively high reward values to states that correspond to improved results in a physical system. For example, the system may assign a high reward value to states that correspond to (a) improving the number of jobs executed across multiple processing nodes (e.g., represented by agents) and (b) reducing the resources, such as memory space, processing capacity, bandwidth, or functions requiring user input that are required to execute the jobs, as compared to alternative states. Additionally, or alternatively, the system may assign a penalty to each state, such that a sequence of actions that arrives at a particular state may be assigned a lower total reward value than another sequence of actions that arrives at the same state with fewer actions.

The system stores a predetermined number of episodes to comprise the training data set for training the agents. In one embodiment, the number of episodes is within a range from tens of thousands of episodes to millions of episodes.

In one embodiment, the system determines if a joint-action value, representing the joint actions of the set of independently operating agents, improves system performance (Operation 266). Maximizing system performance includes executing a set of jobs included in a workflow in the shortest amount of time compared to the time required to execute the same set of jobs with alternative sequences of actions. Additionally, or alternatively, maximizing system performance may include executing the set of jobs in the shortest amount of time while utilizing the fewest possible resources. Maximizing system performance may include executing the set of jobs while meeting defined resource-utilization constraints such as operating processing nodes below a defined processing capacity level. In one embodiment, the system enforces a monotonic joint-action value, which means that the value of a joint action (the collective decision of all agents) should not decrease as individual agents' values increase. This ensures that centralized training decisions are compatible with de-centralized execution policies, and the resulting policy remains consistent even when executed in a decentralized manner.

By repeating the operations 256-266, the system trains the agents representing independently operating processing nodes on the training data set to select actions based on input states of a computing environment (Operation 268). In an embodiment where the agents are neural networks, the system trains the neural networks to embody policies favoring sequences of actions associated with high reward values by providing, for each sequence generated by the neural networks, the associated reward value as feedback to the neural networks. In one or more embodiments, the system may train the neural networks to implement an action-selection policy that takes into account (a) a reward value of a candidate next state associated with a candidate action, (b) a discount factor or penalty associated with the candidate next state, and (c) an estimate of an optimal future value of future next states that follow from the particular candidate next state.

The system generates a job-execution policy based on the set of actions corresponding to the improved joint-action value for the multiple independently operating agents (Operation 270). The job-execution policy may include a set of job-execution policies to be applied to a respective set of processing nodes in a physical system. Alternatively, the job-execution policy may include a single policy applied to the set of processing nodes in the physical system.

In one embodiment, generating the job-execution policy from the sets of actions selected by independently operating agents includes generating sets of rules for processing nodes based on state attributes and action attributes. For example, a set of state attributes provided to a set of agents may specify a set of jobs, where one job has one priority level and one size and another job has another priority level and another size. The system extracts state data, such as job attributes, from the sets of selected actions generate by the agents. The system further extracts the selected actions, representing selections of operations to be performed by processing nodes. The system generates sets of rules by mapping the selected state attributes to the selected action attributes. The system generates the job-execution policy by combining the sets of rules corresponding to the combined selected actions of the agents.

The job-execution policy may include, for example, actions to be performed by a processing node when a set of conditions is detected by the processing node. For example, a set of conditions may include (a) identifying a set of jobs in a workflow that have different attributes, such as priority levels, sizes, and dependencies from other jobs, and (b) attributes of a processing node, such as total processing capacity, current processing capacity, total and current memory capacity, geographic location, and connection attributes with other resources such as bandwidth with other processing nodes or clients. Conditions may further include patterns or sequences of jobs in a workflow. For example, the job-execution policy may result in a Processing Node 1 selecting Job 1 for execution when a set of jobs available for execution includes Job 1, Job 2, and Job 3, and Processing Node 1 just finished executing Job 4. The job-execution policy may result in the Processing Node 1 selecting Job 2 for execution when the same set of jobs is available for execution, but where Processing Node 1 just finished executing Job 5. As described above, based on executing the MARL algorithm on the agents representing processing nodes, the system learns patterns of action selections that improve the overall performance of all the agents, and consequently, of all the processing nodes.

Example actions that may be performed by processing nodes, and that are specified in a job-execution policy, include selecting a job to execute on a processing node, selecting a portion of a job to execute (where another portion may be selected by another processing node), selecting another processing node as a destination of an executed job, refraining from selecting a job to execute, selecting multiple jobs to execute using multiple processing cores of a node, spinning up a virtual machine (VM), spinning down a VM, and remaining idle.

The job-execution policy may include instructions to be implemented by processing nodes such as instructions specifying the following:

When Set A of conditions exists, Node 1 select Job 1 for execution.

When Set B of conditions exists, Node 1 refrain from selecting Job 1 for execution. Node 2 select Job 1 for execution.

When Set C of conditions exists, Node 1 select first part of Job 1 for execution. Node 2 select the second part of Job 1 for execution. Node 2 provide the result of second part of Job 1 as input to Node 1 upon executing the second part of Job 1. Node 1 execute the first part of Job 1 and wait to execute another job until receiving the second part of Job 1. Node 1 outputs the results of executing Job 1.

When Set D of conditions exists, Node 1 select Job 2 for execution.

Conditions specified in the policy may include, for example, attributes of jobs in a queue associated with a pending workflow, attributes of processing nodes, and attributes of a computing system in which the computing nodes operate.

Returning to FIG. 2A, the system implements the job-execution policy in the physical system (Operation 208). The system transmits a set of job-execution policies, corresponding to the set of agents in the MARL algorithm, to a respective set of processing nodes. The job-execution policy may be transmitted as a software module to be executed by the processing nodes. In an alternative embodiment, the system transmits a job-execution policy to a master node among the processing nodes. For example, a set of nodes may operate as a cluster. One of the nodes may be designated as a master node to implement a job-execution policy by distributing jobs among the rest of the nodes. The nodes execute the assigned jobs independently of each other. According to yet another embodiment, the system may transmit the job-execution policy to a job-execution controller or load balancer. The controller or load balancer may distribute jobs among the nodes to allow the nodes to execute the jobs independently of each other.

The system monitors the computing environment state (Operation 210). The computing environment state includes real-time attributes of physical and software components including, and interacting with, the processing nodes. For example, the system may monitor processing capacities of processing nodes, memory capacity of the nodes or external memory, and bandwidth capacity among nodes and external devices. The system further monitors unexecuted jobs in a workflow. For example, the system may store jobs to be executed from one or more workflows in a queue. The system may monitor the queue to determine the number, size, and priority of jobs in the queue.

The system determines if one or more processing nodes has completed executing a corresponding set of one or more jobs (Operation 212). For example, a processing node may transmit to a controller or central register identification information associated with an executed job. In an embodiment where processing nodes select jobs for execution independently of each other, the system may track the jobs selected and executed by the respective nodes.

The system collects job execution results from the processing nodes (Operation 214). Job execution results include data associated with executing the job, such as a time required to execute the job, resources required to execute the job, a size of a software artifact generated by executing the job, and a job destination.

The system provides the job execution results to the MARL engine (Operation 216). The MARL engine applies the MARL algorithm to retrain the set of agents to generate a new job-execution policy to implement in the processing nodes. In some embodiments, the system waits to transmit job-execution results to the MARL engine until a particular trigger is detected. The trigger may correspond to a period of time, such as hourly or daily. The trigger may correspond to a number of executed jobs. For example, the system may collect execution results for ten jobs before transmitting the execution results to the MARL engine to generate and implement a new job-execution policy. In an embodiment, the system waits until a workflow comprising a set of jobs is completed prior to transmitting job-execution results for the set of jobs to a MARL engine to implement the MARL algorithm to train the set of agents.

In one embodiment, the system adds the job-execution results to a training dataset used to train the independently executing agents by the MARL algorithm. Additionally, or alternatively, the system may use the job-execution results to change rewards for particular states. For example, if the system detects from the job-execution results that a processing node took longer to execute a job than was reflected in a previous set of rewards, the system may adjust the reward for a similar state to decrease the reward. The decreased reward reflects the state is less likely to result in a performance benefit among performance of all the agents than if another, more efficient, agent were to execute the job.

The system also determines if a change is detected in the job-execution environment (Operation 218). A change in the job-execution environment may include, for example, a change in a number of jobs in a workflow queue, a change in a number of processing nodes in the computing environment, and a change in a bandwidth or latency between components of the job-execution environment. A change in the computing environment may include a change in the functionality of existing processing nodes. Additionally, or alternatively, performance of a processing node may be upgraded. Alternatively, performance of the processing node may degrade.

If the system determines that the computing environment state has changed, the system collects computing environment state data (Operation 220). The system may collect data specifying how the computing environment has changed. For example, the system may collect data specifying when a processing node performed at a level less than an expected level. The data may include a type of job being processed by the processing node when performance degradation was detected. The data may include a duration of time over which the computing environment change was detected. Some computing environment changes may be temporary or intermittent. Others, such as adding, removing, or changing a processing node, are long-term changes.

In one or more embodiments, the system waits to transmit environment state change data to a MARL engine to retrain a set of agents to generate a new job-execution policy until a threshold level of change is met. For example, a system performance change exceeding 10% from an expected performance may trigger sending environment state change data to the MARL engine. A change in a number of processing nodes may also trigger sending environment state change data to the MARL engine to generate a new job-execution policy.

The system provides the computing environment state data to the MARL engine (Operation 222). The MARL engine applies the MARL algorithm to retrain the set of agents to generate a new job-execution policy to implement in the processing nodes. In one embodiment, the system uses the changed computing environment state data to change rewards for particular environment states. For example, if the system detects from the computing environment state data that a processing node has been upgraded with increased processing capacity, the system may adjust the rewards for certain states that utilize the increased processing capacity to cause a set of jobs in a workflow to be executed by the set of agents faster and/or more efficiently.

In some examples, the change in the computing environment state data causes a change in the MARL algorithm. For example, adding a processing node to a computing environment may cause the system to add an agent component to the MARL algorithm. Removing a processing node from a computing environment may cause the system to remove an agent component from the MARL algorithm.

Based on re-training the agents with the modified MARL algorithm and/or agent training data that is modified based on the modified computing environment state data, the system generates and implements a new job-execution policy in the set of independently operating processing nodes.

One or more embodiments improve systems and operations for deploying applications and infrastructure in a computing environment using a centralized controller and de-centralized processing nodes that each independently determine which processing nodes are to execute which jobs. The centralized controller generates a job-execution policy. The de-centralized processing nodes execute the job-execution policy by obtaining and executing jobs independently of each other or without communicating with other processing nodes to determine the jobs each processing node will execute. The centralized controller generates the job-execution policy using a multi-agent reinforcement learning (MARL) algorithm.

In Multi-Agent Reinforcement Learning (MARL), the learning process involves multiple agents (in this case, representing different servers, nodes, or systems within a deployment pipeline) that together execute jobs in a workflow while making decisions based on their local observations and without information about other agents’ observations.

The algorithm trains agents embodied as software constructs to represent the processing nodes in a physical system. During the training phase, the system centralizes all the agents' experiences (i.e., actions, states, and rewards). This means that the agent interactions, which would typically be independent in de-centralized systems, are shared and jointly processed in a centralized manner. The central controller, or trainer, gathers the experiences of all agents (e.g., deployment nodes) from their individual environments, which include the decisions made during each deployment task and the associated rewards. Centralized training leverages this collective information to optimize the global objective—such as minimizing total deployment time, reducing costs, or improving resource utilization—across all agents. This is achieved by jointly updating the policies of each agent using a global reward signal that reflects the performance of the entire system. Agents learn not only from their own experiences but also from the experiences of other agents. This facilitates global coordination and enables the system to identify optimal strategies for deployment. By training the agents together, centralized training allows for the optimization of system-wide objectives, such as minimizing deployment costs or improving scheduling efficiency. This can lead to higher-quality policies that benefit all agents (nodes) involved in deployment. During training, the system can explore the interactions between agents, learning how the decisions of one agent impact the performance of others. This is crucial in a deployment system, where different nodes may depend on each other or share resources, and coordination is essential for optimal performance.

During training, agents receive state information, such as available actions to take, and select actions independently of each other or without one agent communicating with another to determine the actions the other agents are taking. The actions represent jobs executed by the individual processing nodes in the physical system as a de-centralized execution. For example, in the context of software node deployment, decentralized execution means that, once the training phase is complete, each agent (node or server) acts independently to deploy software updates without relying on a central controller during the actual operation or deployment.

Each processing only observes its local environment (e.g., its own node’s status, the local workload, and available resources) and makes decisions based the policy corresponding to its agent learned via training.

For instance, a deployment node will decide how to assign resources to a specific task, when to process a request, and when to communicate with other nodes (e.g., server handoff or job-sharing) based on its local observations and the knowledge it gained from the MARL framework during the centralized training phase. Since each processing node operates independently, the system can scale to handle a large number of deployment nodes without requiring a centralized decision-making authority for every action, which can become a bottleneck as the system grows. If one node fails or becomes unavailable, the rest of the nodes can continue operating autonomously, making the system more resilient. This also ensures that the failure of one component doesn't disrupt the entire deployment process. Decentralized execution allows for real-time decision-making. Each node can respond quickly to changes in the environment (e.g., a sudden influx of deployment requests or changes in available resources), which is critical in dynamic environments like CI/CD systems. De-centralized execution allows each agent to adapt to its specific needs and constraints. For example, some nodes may be more powerful and handle larger tasks, while others can focus on smaller, quicker deployment jobs.

The MARL algorithm uses a joint-action value to reward agents for actions that result in maximizing the combined performance of all the agents. In an embodiment, the MARL algorithm utilizes a monotonic joint-action value to ensure that the centralized training and de-centralized execution are consistent. The monotonic joint-action value means that the value of a joint action (the collective decision of all agents) should not decrease as individual agents' values increase. This ensures that centralized training decisions are compatible with de-centralized execution policies, and the resulting policy remains consistent even when executed in a de-centralized manner.

In one or more embodiments, the system utilizes deployment job-sharing and multi-deployment strategies to enhance node resource utilization. By distributing deployment jobs across multiple nodes and later converging these jobs before the final deployment stage, the system becomes more adaptable, capable of adjusting to fluctuating workloads. This approach allows the system to efficiently balance a workload among various nodes, preventing any single node from becoming overburdened while maximizing the use of available resources. This marks a notable advancement compared to traditional systems, where deployment jobs are typically assigned to specific nodes or servers. In such systems, this static allocation often leads to inefficiencies, as certain nodes may remain underutilized or overburdened, resulting in suboptimal resource utilization and performance.

In one embodiment, the system matches deployment requests with dispatch decisions using a greedy approach, which is further optimized for improved dispatch reliability and efficiency. This integration proves especially effective in real-world systems, where balancing multiple conflicting objectives (such as cost, time, and resource constraints) is essential.

One or more embodiments improve processes for deployment and scheduling of computing resources by decomposing deployment processes into two closely integrated components: software-update-deployment and software-package-matching. A deployment policy is designed to allow processing nodes to manage decisions regarding the deployment of an application or infrastructure based on deployment requests. It utilizes a MARL framework to generate, in a centralized end-to-end fashion, policies to be executed in a de-centralized manner. The MARL framework incorporates a joint action-value estimation network, which represents a non-linear combination of individual agent values based only on local observations.

One or more embodiments employ an efficient matching algorithm to pair deployment requests with dispatch decisions. The algorithm uses a greedy approach combined with multiple updates to minimize overall system time consumption. The matching process is further improved by integrating a specialized optimizer to enhance dispatch and assignment decisions, ensuring both reliability and efficiency in the system.

One or more embodiments apply off-policy learning during MARL training of agents to ensure that agents can learn from experiences outside of their own direct interactions, and to ensure that centralized training can simulate different possible scenarios to improve agents’ decision-making. The application of off-policy learning provides a tractable training of the agents, meaning that even though each agent is learning individually (de-centralized execution), the system as a whole can improve global performance.

### 4. Example Embodiment

A detailed example is described below for purposes of clarity. Components and/or operations described below should be understood as one specific example that may not be applicable to certain embodiments. Accordingly, components and/or operations described below should not be construed as limiting the scope of any of the claims.

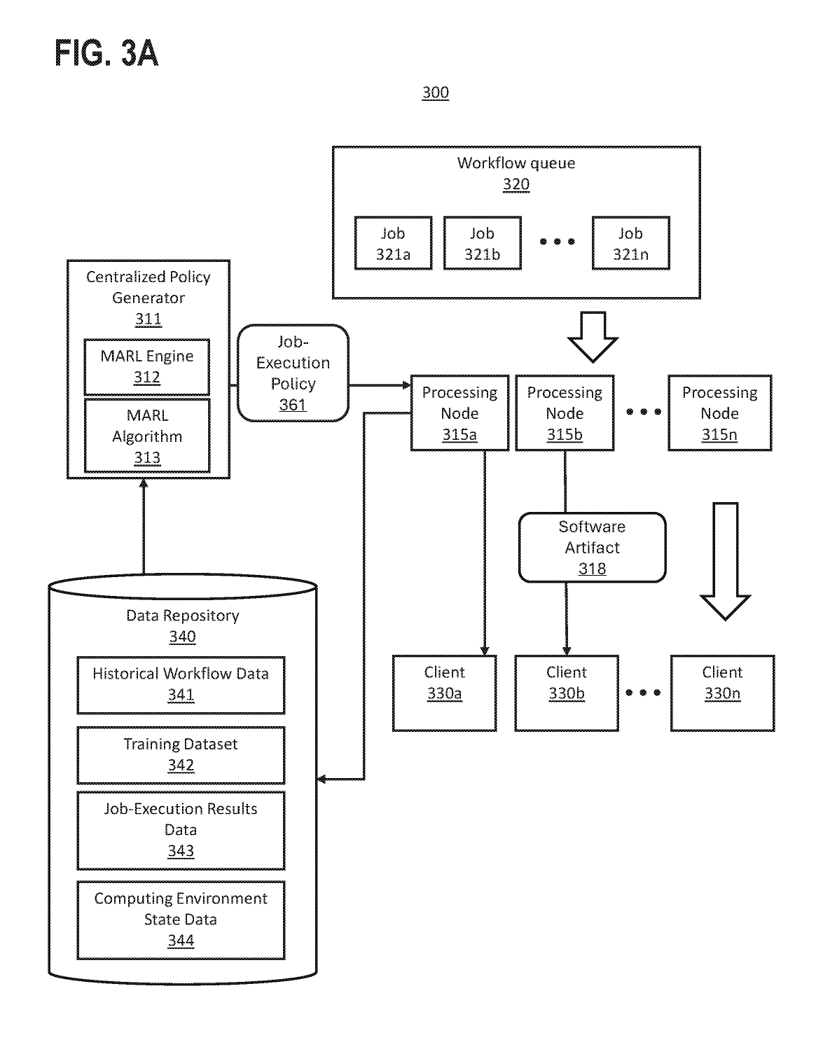

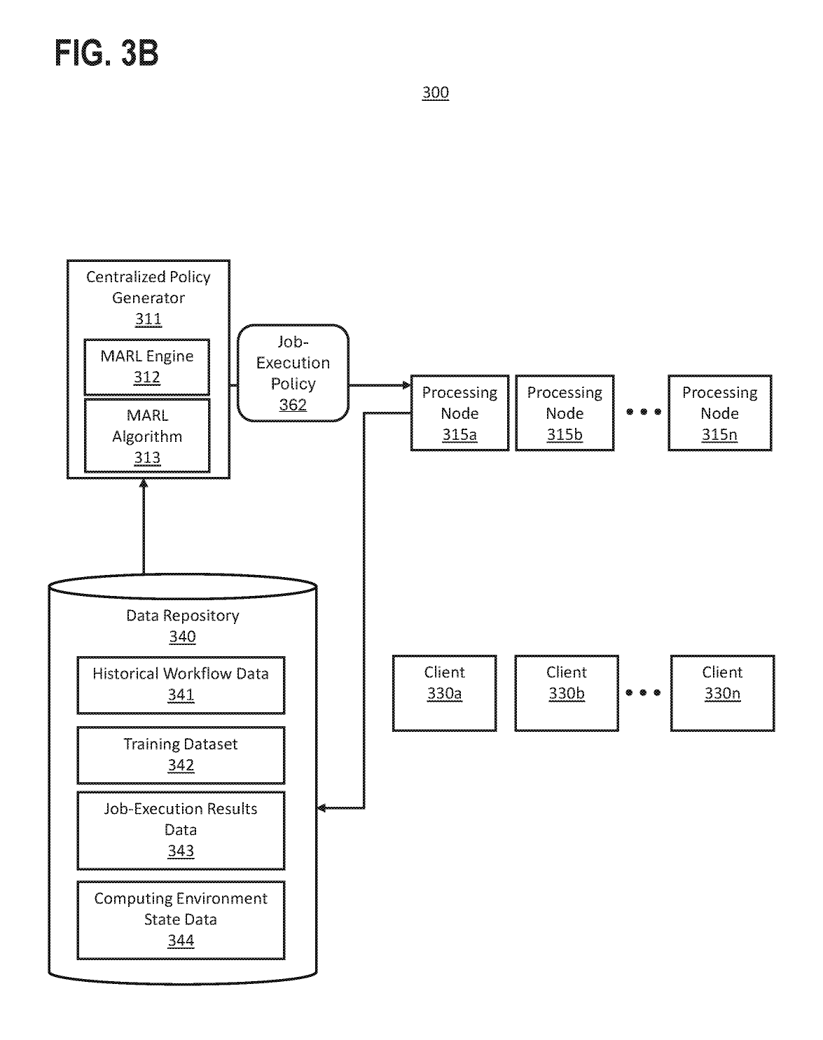

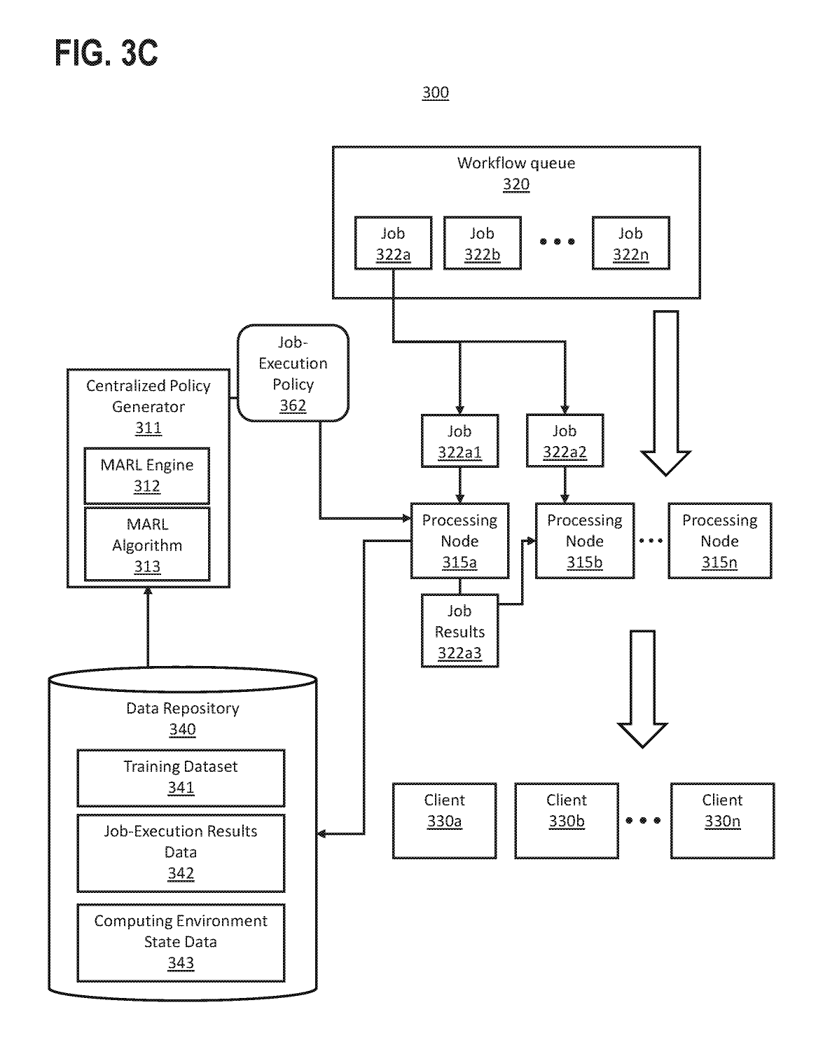

FIG. 3A illustrates an example system 300 for centrally generating a job-execution policy that is implemented in a de-centralized manner by independently operating processing nodes 315a-315n. A centralized policy generator 311 obtains a set of historical workflow data 341 from a data repository 340. The historical workflow data 341 includes historical records of jobs executed by the processing nodes 315a-315n and results of the job executions. The MARL engine 312 generates a training dataset 342 based on the historical workflow data 341. The training dataset 342 specifies possible agent actions based on historical computing environment states, including processing node states and workflow states. The MARL engine 312 iteratively applies a MARL algorithm 313 to a set of independently executing agents to train the agents to select an optimal sequence of actions to execute the set of jobs comprised in the historical workflow data 341.

Based on the optimal sequence of actions, the centralized policy generator 311 generates a job-execution policy 361. The job-execution policy specifies conditions a processing node may observe and actions the processing node should take based on the observed conditions. In the example embodiment, the job-execution policy 361 is a software module comprising sets of instructions run on the processing nodes 315a-315n. The processing nodes 315a-315n execute the instructions to determine actions to perform such as jobs to select for execution.

The processing nodes 315a-315n access a workflow queue 320. The workflow queue 320 comprises jobs 321a-321n. In the example embodiment, any processing node 315a-315n may select any job 321a-321n for execution. Jobs include generating software artifacts and interacting with client devices 330a-330n to cause the client devices 330a-330n to perform certain operations.

In the example of FIG. 3A, processing node 315a selects Job 321b for execution. Processing node 315b selects Job 321a for execution. Processing node 315a interacts with client 330a to perform a set of operations on client 330a. For example, processing node 315a may reconfigure a set of values in a register maintained by an application hosted by client 330a. Processing node 315b compiles a software artifact 318 to be executed on client 330b.

While FIG. 3A illustrates processing nodes 315a and 315b executing jobs in a same workflow to interact with different clients 330a and 330b, some workflows comprise jobs that cause different processing nodes to interact with the same client. For example, a workflow to upgrade a software application in client 330a may comprise processing node 315a interacting with client 330a to transfer data from one location in the client to another. Meanwhile, processing node 315b may generate a software artifact 318 comprising data to be provided to client 330a once the transfer of data has been completed.

Referring to FIG. 3B, based on completing the jobs 321a-321n in the workflow queue 320, the processing nodes 315a-315n store job-execution results data 343 in the data repository 340. The system 300 further stores computing environment state data 344 in the data repository 340. For example, the system 300 may store data indicating that processing node 315b was upgraded to have more processing capacity.

The MARL engine 312 obtains the job-execution results data 343 and computing environment state data 344. The MARL engine 312 obtains the job-execution results data 343 and computing environment state data 344. The MARL engine 312 applies the MARL algorithm 313 to the independent agents to retrain the agents based on the job-execution results data 343 and the computing environment state data 344. The MARL engine 312 may incorporate the job-execution results data 343 and computing environment state data 344 into the training dataset 342 to retrain the agents.

Based on retraining the agents, the centralized policy generator 311 generates a new job-execution policy 362. The job-execution policy 362 specifies conditions a processing node may observe and actions the processing node should take based on the observed conditions. In the example embodiment, the job-execution policy 362 is a software module comprising sets of instructions run on the processing nodes 315a-315n. The processing nodes 315a-315n execute the instructions to determine actions to perform, such as jobs to select for execution.

FIG. 3C illustrates processing nodes 315a-315n employing the job-execution policy 362 to execute a set of jobs 322a-322n in the workflow queue 320. Processing node 315a implements the job-execution policy to divide Job 322a into a first part 322a1 and a second part Job 322a2. Processing node 315a executes the first part Job 322a1. Processing node 315b implements the job-execution policy 362 independently of processing node 315a to divide job 322a into the first part 322a1 and the second part Job 322a2. Processing node 315b executes the second part Job 322a2. In other words, the job-execution policy 362 specifies that when Set of Conditions A is met associated with a Job B, one processing node with a set of attributes C should take a first part of Job B for execution, and another processing node with a set of attributes D should take a second part of Job B for execution.

Based on determining Conditions A are met, Job 322a corresponds to the attributes of Job B, and it has the attributes C specified in the Job-Execution Policy 362, processing node 315a divides job 322a and executes the part Job 322a1. Based on determining, independently of processing node 315a, that Conditions A are met, Job 322a corresponds to the attributes of Job B, and it has the attributes D specified in the Job-Execution Policy 362, processing node 315b divides job 322a and executes the part Job 322a2.

Processing node 315a further implements instructions in the job-execution policy 362 to send the job results 322a3 from executing Job 322a1 to processing node 315b. Processing node 315b further implements instructions in the job-execution policy 362 to receive the job results 322a3, to combine the job results 322a3 with results from executing Job 322a2, and to transmit the combined results to clients 330a-330n.

As additional workflows are completed and received, the system 300 iteratively retrains agents using the MARL algorithm 313, generates job-execution policies based on previous job-execution results, and implements the policies in the computing environment.

Conventional orchestration platforms identify workflows to distribute to clients and send the workflows to processing nodes to process jobs to deliver software and services to clients. For example, if an entity needs to update applications in clients, the entity generates a software artifact and sends the software artifact to geographically distanced nodes to deliver to clients. However, workflows associated with software goods and services are not uniformly resource intensive. Furthermore, processing nodes are not uniformly efficient at processing workflows. Accordingly, distributing goods and services equally among processing nodes results in delivery delays.

Embodiments apply a MARL algorithm to sets of jobs associated with workflows to generate policies that meet optimization criteria for processing workflows. The MARL algorithm trains multiple agents that correspond to different processing nodes. Agent attributes may be mapped to processing node attributes. The MARL algorithm trains the agents to select a set of actions that meets optimization criteria for executing jobs to process workflows. The agents utilize techniques, including job-splitting, job-combining, and job selection, based on job and agent attributes to determine the set of actions that meets the optimization criteria. The agents act independently from each other without communicating the actions the agents will select. However, the MARL algorithm rewards the agents based on the combined selections of the agents. Accordingly, the agents learn to select actions that result in an overall benefit to the agents rather than a benefit to the agent making the selection. The system generates the job-execution policy based on the set of actions selected by the agents. Processing nodes in a computing environment implement the job-execution policy independently of each other to process workflows. Since the system generates the policy from a set of agent selections that meet overall optimization criteria for the set of agents and not just a single selecting agent, the processing nodes implement the policy in a manner that results in an overall optimization of processing a workflow rather than optimizing a processing node executing a job in the workflow.

### 5. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

### 6. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

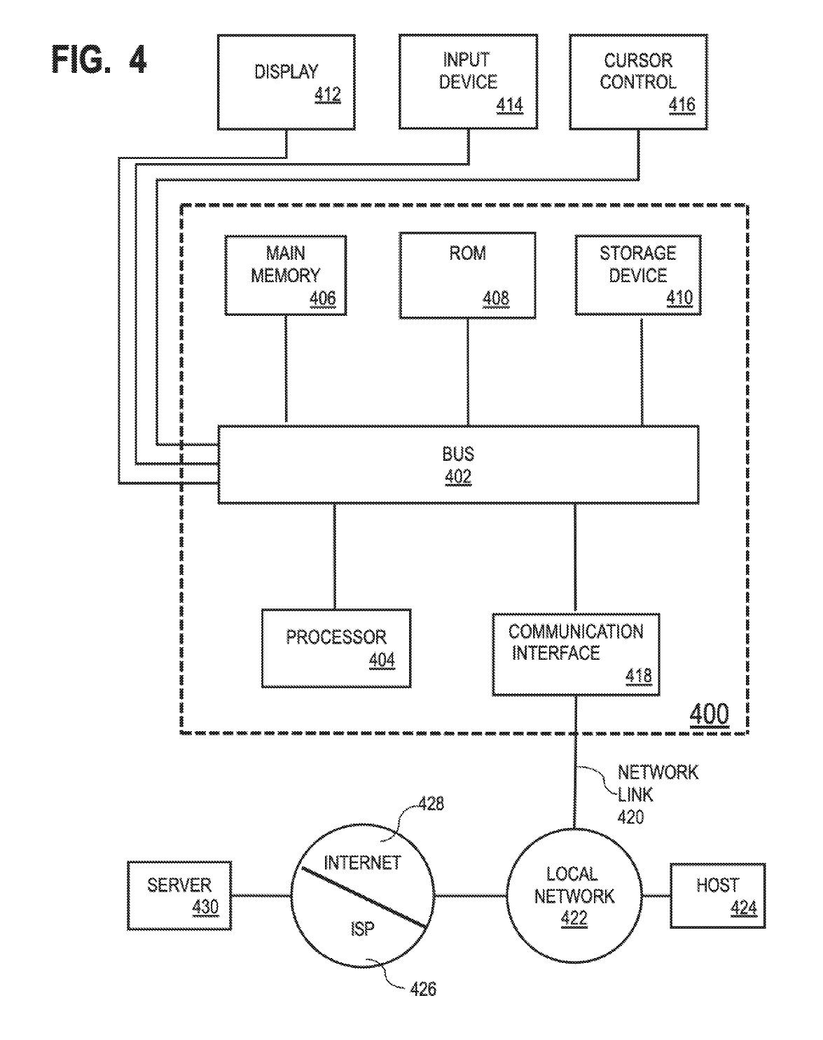

For example, FIG. 4 is a block diagram that illustrates a computer system 400 upon which an embodiment of the disclosure may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or a Solid State Drive (SSD) is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 410. Volatile media includes dynamic memory, such as main memory 406. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the worldwide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

### 7. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer readable media comprising instructions which, when executed by one or more hardware processors, cause performance of operations comprising:
obtaining a first set of historical job-execution data specifying (a) a first historical set of jobs, and (b) a first historical allocation of computing resources to execute the first historical set of jobs;
applying a multi-agent reinforcement learning (MARL) algorithm to train a set of agents, including at least a first agent and a second agent, to generate a set of joint actions based on the historical job-execution data;
generating a first policy based on the set of joint actions, wherein the first policy comprises instructions for a set of processing nodes to execute sets of jobs,
wherein applying the MARL algorithm includes simulating execution of the first historical set of jobs by the set of agents,
obtaining a first set of jobs to be executed by a set of processing nodes, including a first processing node and a second processing node, wherein the first processing node comprises functionality to execute both a first job and a second job, among the first set of jobs, and wherein the second processing node comprises functionality to execute both the first job and the second job;
based on the first policy, a first set of attributes associated with the first job, a second set of attributes associated with the second job, a third set of attributes associated with the first processing node, and a fourth set of attributes associated with the second processing node:
determining, by the first processing node, that the first job is to be executed by the first processing node and the second job is to be executed by the second processing node; and
determining, by the second processing node, independently of the first processing node, that the first job is to be executed by the first processing node and the second job is to be executed by the second processing node;
executing, by the first processing node, the first job; and
executing, by the second processing node, the second job.

2. The one or more non-transitory computer readable media of claim 1, wherein the operations further comprise:
based on executing, by the first processing node, the first job: generating a second set of historical job-execution data including data corresponding to execution of the first job by the first processing node;
applying the MARL algorithm to retrain the set of agents based on the second set of historical job-execution data to generate a second policy; and
deploying the second policy to the set of processing nodes.

3. The one or more non-transitory computer readable media of claim 1, wherein determining, by the first processing node, that the first job is to be executed by the first processing node comprises:
determining a first set of characteristics of the first job;
identifying a set of instructions in the first policy matching the first set of characteristics corresponding to a type of job to a second set of characteristics corresponding to a type of processing node; and
determining the first processing node is to execute the first job based on matching the first set of characteristics of the first job with the second set of characteristics of the first processing node.

4. The one or more non-transitory computer readable media of claim 3, wherein the first set of characteristics comprises at least one of job priority, job size, and job destination.

5. The one or more non-transitory computer readable media of claim 3, wherein the second set of characteristics comprises at least one of processing capacity, memory capacity, and bandwidth.

6. The one or more non-transitory computer readable media of claim 1, wherein a number of processing nodes in the set of processing nodes equals a number of agents included in the set of agents.

7. The one or more non-transitory computer readable media of claim 1, wherein the first agent is characterized by a first set of attributes based on a second set of attributes corresponding to the first processing node, and
wherein the second agent is characterized by a third set of attributes based on a fourth set of attributes corresponding to the first processing node.

8. The one or more non-transitory computer readable media of claim 1, wherein the first processing node determines that the first job is to be executed by the first processing node without communicating with the second processing node.

9. The one or more non-transitory computer readable media of claim 1, wherein the set of processing nodes comprises at least a third processing node,
wherein the operations further comprise:
determining, by the first processing node based on the first policy, that the first job executed by the first processing node, and the second job executed by the second processing node, are to be transmitted to the third processing node to be further processed as a third job by the third processing node.

10. The one or more non-transitory computer readable media of claim 1, wherein the operations further comprise:
determining, by the first processing node based on the first policy, that a third job is to be divided into a first sub-job and a second sub-job, that the first processing node is to execute the first sub-job; and
determining, by the second processing node based on the first policy and independently of the first processing node, that the third job is to be divided into the first sub-job and the second sub-job, that the second processing node is to execute the second sub-job;
executing, by the first processing node, the first sub-job; and
executing, by the second processing node, the second sub-job.

11. The one or more non-transitory computer readable media of claim 1, wherein the first policy corresponds to a first set of priorities for completing the first historical set of jobs,
wherein the operations further comprise:
detecting an input to select a second set of priorities for completing the first historical set of jobs; and
based on detecting the input to select the second set of priorities for completing the first historical set of jobs:
modifying a set of rewards applied by the MARL to train the set of agents;
applying the MARL algorithm to train the set of agents to generate a second policy based on the second set of priorities; and
applying, by the set of processing nodes, the second policy to execute a second set of jobs.

12. A method comprising:
obtaining a first set of historical job-execution data specifying (a) a first historical set of jobs, and (b) a first historical allocation of computing resources to execute the first historical set of jobs;
applying a multi-agent reinforcement learning (MARL) algorithm to train a set of agents, including at least a first agent and a second agent, to generate a set of joint actions based on the historical job-execution data;
generating a first policy based on the set of joint actions, wherein the first policy comprises instructions for a set of processing nodes to execute sets of jobs,
wherein applying the MARL algorithm includes simulating execution of the first historical set of jobs by the set of agents,
obtaining a first set of jobs to be executed by a set of processing nodes, including a first processing node and a second processing node, wherein the first processing node comprises functionality to execute both a first job and a second job, among the first set of jobs, and wherein the second processing node comprises functionality to execute both the first job and the second job;
based on the first policy, a first set of attributes associated with the first job, a second set of attributes associated with the second job, a third set of attributes associated with the first processing node, and a fourth set of attributes associated with the second processing node:
determining, by the first processing node, that the first job is to be executed by the first processing node and the second job is to be executed by the second processing node; and
determining, by the second processing node, independently of the first processing node, that the first job is to be executed by the first processing node and the second job is to be executed by the second processing node;
executing, by the first processing node, the first job; and
executing, by the second processing node, the second job,
wherein the method is performed by at least one device including a hardware processor.

13. The method of claim 12, further comprising:
based on executing, by the first processing node, the first job: generating a second set of historical job-execution data including data corresponding to execution of the first job by the first processing node;
applying the MARL algorithm to retrain the set of agents based on the second set of historical job-execution data to generate a second policy; and
deploying the second policy to the set of processing nodes.

14. The method of claim 12, wherein determining, by the first processing node, that the first job is to be executed by the first processing node comprises:
determining a first set of characteristics of the first job;
identifying a set of instructions in the first policy matching the first set of characteristics corresponding to a type of job to a second set of characteristics corresponding to a type of processing node; and
determining the first processing node is to execute the first job based on matching the first set of characteristics of the first job with the second set of characteristics of the first processing node.

15. The method of claim 14, wherein the first set of characteristics comprises at least one of job priority, job size, and job destination.

16. The method of claim 14, wherein the second set of characteristics comprises at least one of processing capacity, memory capacity, and bandwidth.

17. The method of claim 12, wherein a number of processing nodes in the set of processing nodes equals a number of agents included in the set of agents.

18. The method of claim 12, wherein the first agent is characterized by a first set of attributes based on a second set of attributes corresponding to the first processing node, and
wherein the second agent is characterized by a third set of attributes based on a fourth set of attributes corresponding to the first processing node.

19. The method of claim 12, wherein the first processing node determines that the first job is to be executed by the first processing node without communicating with the second processing node.

20. A system comprising:
at least one device including a hardware processor;
the system being configured to perform operations comprising:
obtaining a first set of historical job-execution data specifying (a) a first historical set of jobs, and (b) a first historical allocation of computing resources to execute the first historical set of jobs;
applying a multi-agent reinforcement learning (MARL) algorithm to train a set of agents, including at least a first agent and a second agent, to generate a set of joint actions based on the historical job-execution data;
generating a first policy based on the set of joint actions, wherein the first policy comprises instructions for a set of processing nodes to execute sets of jobs,
wherein applying the MARL algorithm includes simulating execution of the first historical set of jobs by the set of agents,
obtaining a first set of jobs to be executed by a set of processing nodes, including a first processing node and a second processing node, wherein the first processing node comprises functionality to execute both a first job and a second job, among the first set of jobs, and wherein the second processing node comprises functionality to execute both the first job and the second job;
based on the first policy, a first set of attributes associated with the first job, a second set of attributes associated with the second job, a third set of attributes associated with the first processing node, and a fourth set of attributes associated with the second processing node:
determining, by the first processing node, that the first job is to be executed by the first processing node and the second job is to be executed by the second processing node; and
determining, by the second processing node, independently of the first processing node, that the first job is to be executed by the first processing node and the second job is to be executed by the second processing node;
executing, by the first processing node, the first job; and
executing, by the second processing node, the second job.
